(19) United States
(12) Patent Application Publication
(10) Pub. No.: US 2024/0161075 A1
(43) Pub. Date: May 16, 2024

(54) SYSTEMS AND METHODS FOR DYNAMIC ESCROW MANAGEMENT

(71) Applicant: JPMORGAN CHASE BANK, N.A., New York, NY (US)

(72) Inventors: John THOMAS, Brooklyn, NY (US); Thomas M. RIZZO, Apollo Beach, FL (US); Saravanan IYYANAR, Seffner, FL (US); Kaushik NAGARAJ, Brooklyn, NY (US)

(21) Appl. No.: 18/054,459

(22) Filed: Nov. 10, 2022

(51) Int. Cl. G06Q 20/10

(52) U.S. Cl. CPC G06Q 20/108

(57) ABSTRACT

Systems and methods for dynamic escrow management are disclosed. A method executed by an escrow management computer program may include: receiving an escrow agreement between a first party and a second party to a deal; extracting, using natural language processing, identifications of and authorized signors for the first party and the second party and terms of the escrow agreement; receiving an escrow deposit from the first party or the second party; confirming that an amount of the escrow deposit meets a term of the escrow agreement; depositing the escrow deposit into an escrow account; receiving an escrow instruction from the first party as a completed instruction template at a web interface; retrieving an identification of authorized signor for the first party; routing the escrow instruction to the authorized signor from the first party; receiving approval for the escrow instruction; and causing execution of the escrow instruction.

### BACKGROUND OF THE INVENTION

### 1. Field of the Invention

Embodiments are generally directed to systems and methods for dynamic escrow management.

### 2. Description of the Related Art

An escrow is generally a multi-lateral legal arrangement in which assets are deposited with a neutral third party (e.g., a bank or other deposit facilitator) to support the fulfillment of certain conditions set forth in an underlying legal agreement. Escrow arrangements are used to mitigate risks that pertain to an underlying transaction, for example, an acquisition.

The process of documenting, managing, and executing changes to an account that is subject to an escrow agreement is referred to as “post-onboarding” because these actions can only occur once parties have been “onboarded” into the escrow deal repository system. An “escrow agent” acts as an independent third party to the transaction which holds and releases assets pursuant to specific conditions in the escrow agreement.

Common types of actions parties may be able to take in relation to the escrow account include filing claims and claim objections, filing instructions to disburse part or all of the assets in escrow, changing authorized representatives, etc.

Instructions and claims are processed using traditional communication channels (e.g., e-mail, fax, mail, etc.) and are not currently centralized for parties to view and make changes in real-time. When received by the escrow agent, the instructions are uploaded to a central repository that is only visible to the escrow agent. Submitting a claim, claim objection, or an instruction to the escrow agent can be a cumbersome task for clients.

### SUMMARY OF THE INVENTION

Systems and methods for dynamic escrow management are disclosed. In one embodiment, a method for dynamic escrow management may include: (1) receiving, by an escrow management computer program executed by an electronic device, an escrow agreement between a first party and a second party to a deal; (2) extracting, by the escrow management computer program and using natural language processing, an identification of the first party, an identification of the second party, terms of the escrow agreement, and an identification of authorized signors for the first party and the second party; (3) receiving, by the escrow management computer program, an escrow deposit from the first party or the second party; (4) confirming, by the escrow management computer program, that an amount of the escrow deposit meets a term of the escrow agreement; (5) depositing, by the escrow management computer program, the escrow deposit into an escrow account; (6) receiving, by the escrow management computer program, an escrow instruction from the first party, wherein the escrow instruction is received as a completed instruction template at a web interface; (7) retrieving, by the escrow management computer program, an identification of authorized signor for the first party; (8) routing, by the escrow management computer program, the escrow instruction to the authorized signor from the first party; (9) receiving, by the escrow management computer program, approval for the escrow instruction; and (10) causing, by the escrow management computer program, execution of the escrow instruction.

In one embodiment, the escrow management computer program may predict the authorized signors using a trained machine learning engine.

In one embodiment, the method may also include enrolling, by the escrow management computer program, the authorized signor for the first party in online access to the escrow management computer program.

In one embodiment, the method may also include performing, by the escrow management computer program, due diligence on the first party and the second party.

In one embodiment, the escrow instruction may include a release of the escrow deposit.

In one embodiment, the method may also include storing, by the escrow management computer program, the approval for the escrow instruction.

In one embodiment, the approval for the escrow instruction may include an electronic signature for the authorized signor for the first party.

In one embodiment, a payment system may be configured to execute the escrow instruction.

According to another embodiment, a system may include: a first party electronic device for a first party; a dynamic template database comprising a plurality of dynamic templates; an escrow account; an escrow management computer program executed by an electronic device that receives an escrow agreement between the first party and a second party to a deal from the first party electronic device, extracts, using natural language processing, an identification of the first party, an identification of the second party, terms of the escrow agreement, and an identification of authorized signors for the first party and the second party, receives an escrow deposit from the first party or the second party, confirms that an amount of the escrow deposit meets a term of the escrow agreement, deposits the escrow deposit into the escrow account, receives an escrow instruction from the first party electronic device, wherein the escrow instruction is received as a completed dynamic template from the dynamic template database, retrieves an identification of authorized signor for the first party, routes the escrow instruction to the authorized signor from the first party, receives approval for the escrow instruction, and causes execution of the escrow instruction; and a payment system that receives and executes the escrow instruction.

In one embodiment, the escrow management computer program may predict the authorized signors using a trained machine learning engine.

In one embodiment, the escrow management computer program may enroll the authorized signor for the first party in online access to the escrow management computer program.

In one embodiment, the escrow management computer program may perform due diligence on the first party and the second party.

In one embodiment, the escrow instruction may include a release of the escrow deposit.

In one embodiment, the system may also include a deal database, and the escrow management computer program may store the approval for the escrow instruction in the deal database.

In one embodiment, the approval for the escrow instruction may include an electronic signature for the authorized signor for the first party.

According to another embodiment, a non-transitory computer readable storage medium, may include instructions stored thereon, which when read and executed by one or more computer processors, cause the one or more computer processors to perform steps comprising: receiving an escrow agreement between a first party and a second party to a deal; extracting, using natural language processing, an identification of the first party, an identification of the second party, terms of the escrow agreement, and an identification of authorized signors for the first party and the second party; receiving an escrow deposit from the first party or the second party; confirming that an amount of the escrow deposit meets a term of the escrow agreement; depositing the escrow deposit into an escrow account; receiving an escrow instruction from the first party, wherein the escrow instruction is received as a completed instruction template at a web interface; retrieving an identification of authorized signor for the first party; routing the escrow instruction to the authorized signor from the first party; receiving approval for the escrow instruction; and causing execution of the escrow instruction.

In one embodiment, the authorized signors may be predicted using a trained machine learning engine.

In one embodiment, the escrow instruction may include a release of the escrow deposit.

In one embodiment, the non-transitory computer readable storage medium may also include instructions stored thereon, which when read and executed by one or more computer processors, cause the one or more computer processors to store the approval for the escrow instruction.

In one embodiment, the approval for the escrow instruction may include an electronic signature for the authorized signor for the first party.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 depicts a system for dynamic escrow management according to one embodiment;

FIG. 2 depicts a method for dynamic escrow management according to one embodiment;

FIG. 3 depicts an exemplary computing system for implementing aspects of the present disclosure.

### DETAILED DESCRIPTION OF PREFERRED EMBODIMENTS

Embodiments generally relate to systems and methods for dynamic escrow management.

In embodiments, an escrow management computer program may provide a portal that allows clients to interact with other deal parties, draft, submit, electronically sign, and track instructions in real time virtually. In contrast to post onboarding activities that are normally conducted via phone, email, or fax, embodiments provide a secure submission channel that supplements existing communication methods between deal parties and the escrow agent.

Embodiments create efficiencies for clients and mitigate a variety of risks that are faced by the escrow agent. The risk of fraud is reduced due to the use of a secure digitalized channel directly from escrow parties to the escrow agent. The post onboarding portal may also serve as a centralized document repository for clients for deal information.

In embodiments, parties may also electronically sign documents, and the authority of the signors may be validated by the escrow management computer program.

In embodiments, clients may provide instructions using customizable instruction templates. Clients may also draft instructions collaboratively with their respective party members, submit the instructions to the escrow agent, and electronically sign the instructions.

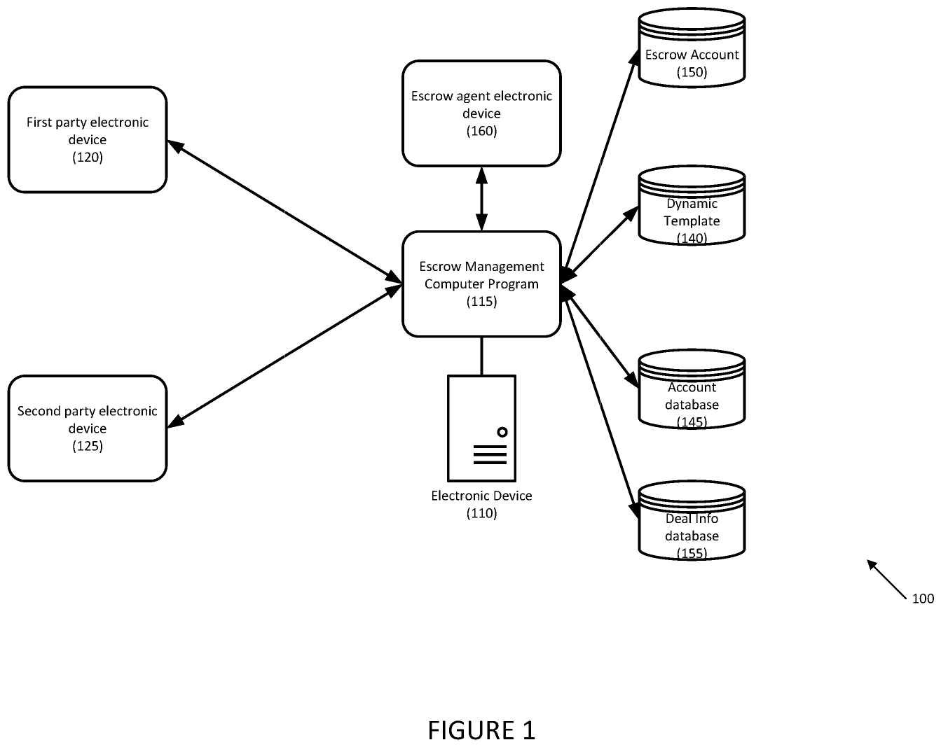

Referring to FIG. 1, a system for dynamic escrow management is provided according to an embodiment. System 100 may include electronic device 110 that may execute escrow management computer program 115. Electronic device 110 may be any suitable electronic device, including servers (e.g., physical and/or cloud-based), computers (e.g., workstations, desktops, laptops, notebooks, tablets, etc.), smart devices, Internet of Things (IoT) appliances, etc.

Escrow management computer program 115 may be a computer program, application, etc. that may interface with parties to an escrow or deal (e.g., first party electronic device 120 for a first party, and second party electronic device 125 for a second party, as well as representatives of the parties (not shown). Escrow management computer program 115 may also interface with dynamic template database 140, account database 145, escrow account 150, and deal information database 155.

Account database 145 may maintain a listing of different accounts, including accounts to fund escrow account 150, and accounts to receive funds from escrow account 150.

Deal information database 155 may maintain information related to the underlying deal for the escrow. Deal information database 155 may store, for example, the escrow agreement, completed forms (e.g., completed templates), escrow instructions, communications, etc.

Escrow agent electronic device 160 may be an electronic device that is associated with an escrow agent that may oversee operation of escrow management computer program 115. Escrow agent electronic device 160 may receive notifications from escrow management computer program 115.

Escrow management computer program 115, first party electronic device 120 and second party electronic device 125 may communicate over any suitable communication network, including the Internet.

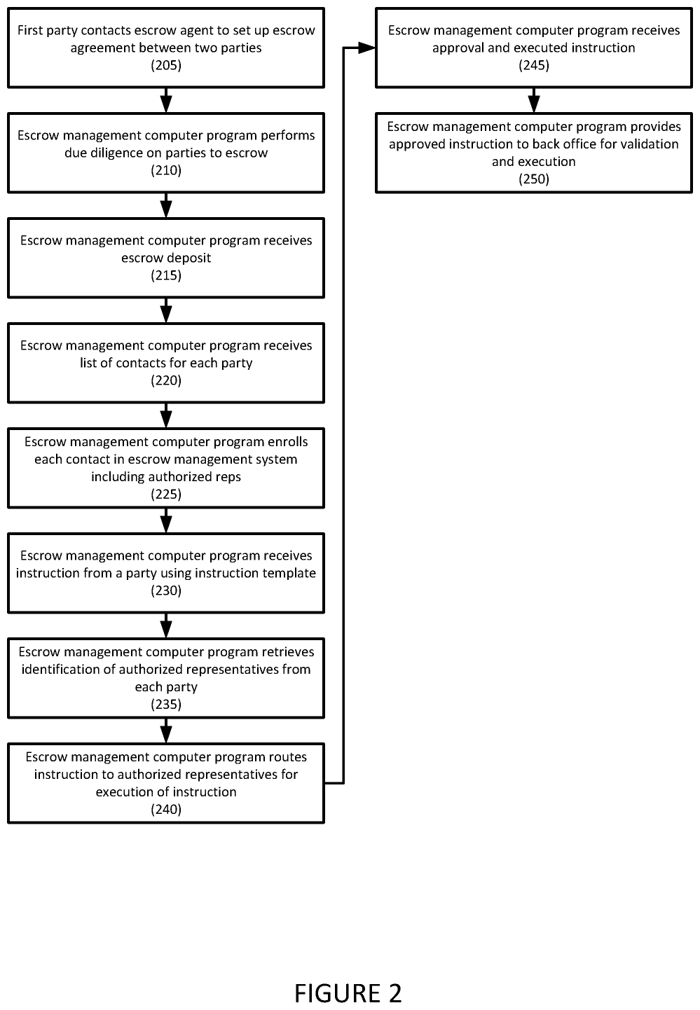

Referring to FIG. 2, a method for dynamic escrow management is provided according to an embodiment.

In step 205, a first party, such as a client of a financial institution, may contact an escrow agent at the financial institution to set up an escrow between two parties to a deal, such as the first party and a second party. The first party may access a computer program, such as an escrow management computer program, that may be executed by an electronic device, using a first party electronic device.

In one embodiment, the first party may provide the escrow management computer program with an escrow agreement between the parties for the escrow. The escrow agreement may identify the parties, the authorized signors for each party, the terms of the escrow, etc.

In one embodiment, the first party may provide the escrow agreement and the escrow management computer program may use natural language processing or similar to identify the parties, the terms of the escrow, the authorized signors for each party, etc.

In another embodiment, a representative of the first party may enter the escrow agreement information, the authorized signors, etc. into fields provided in a user interface.

In one embodiment, machine learning and/or artificial intelligence may be used to predict certain events, personnel (e.g., authorized signors), etc. based on the escrow agreement and/or the identification of the parties. For example, a machine learning model may be trained, based on prior agreements, an authorized signor based on the party, the type of deal, the amount of the deal, etc.

In step 210, the escrow management computer program may perform due diligence on the parties to the deal or escrow. For example, the escrow management computer program may perform Know Your Customer (KYC) checks on the first party, and may also perform the KYC checks on the second party.

In step 215, the escrow management computer program may receive an escrow deposit from the first party or the second party. For example, the escrow management computer program may receive escrow funds via a wire transfer, an ACH, a check, cryptocurrency, etc. and may deposit the funds into an escrow account. In one embodiment, the escrow management computer program may verify that the amount of the funds deposited matches the amount of funds specified in the escrow agreement. If there is a discrepancy, the escrow management computer program may notify the parties of the discrepancy.

In step 220, if not already received, the escrow management computer program may receive a list of contacts for each party. For example, contacts may be received at various pre-closing stages—during KYC, during the receipt of the escrow and/or deal agreement, etc. In addition, contacts may be updated at closing or at any other time that a contact may change.

More than one type of contact may be received. For example, authorized signors may be authorized to sign agreements and instructions. Other contacts, such as stakeholders or intermediaries (e.g., attorneys), may not have signing rights.

Once received, the contacts may be associated with the deal and may be saved.

In step 225, the escrow management computer program may enroll each contact, authorized signors, etc. in the escrow management system. This may include, for example, entering contact information for notifications into the escrow management system, establishing an online account (e.g., with login credentials) for each contact and authorized signor, etc.

In step 230, the escrow management computer program may receive an escrow instruction from the first party or the second party using instruction template. For example, a representative of the first party or the second party may access the escrow management computer program at a web interface and via a secure connection, and may provide the escrow instruction by, for example, selecting a template and entering information into the fields in the template. The escrow management computer program may confirm that the template has all required information before the template is submitted.

In one embodiment, the escrow management computer program may also pre-populate account numbers and other relevant information into the template, so the representative does not need to re-input this information.

The representative submitting the escrow instruction may not be an authorized signor and may only provide the escrow instruction.

After the escrow instruction is inputted, in step 235, the escrow management computer program may retrieve the identification of authorized representatives from each party. In step 240, the escrow management computer program may route the escrow instruction to the authorized representatives necessary for authorization to execute the escrow instruction. For example, if an authorized signor from the first party is needed, the escrow management computer program may route the escrow instruction to the authorized signor for approval.

In one embodiment, the escrow management computer program may send a notification to the authorized representatives and the authorized representatives may approve or deny the escrow instruction via a user interface.

In step 245, the escrow management computer program may receive approval and executed instruction. For example, the escrow management computer program may receive an electronic signature for the authorized representative and may record the decision and the electronic signature.

In one embodiment, the escrow management computer program may record audit trail information, such as a timestamp and IP address of signing event, as well as a history of actions taken (e.g., submit, e-sign, reject).

If the representative is not an authorized signor, the escrow management computer program may route the approval to the authorized signor for approval in a similar manner.

In step 250, the escrow management computer program may provide the approved instruction to a back office for the financial institution for validation and execution. For example, for payment instructions, after the internal approvals, the payment instruction may flow to a payment system to make the actual payment.

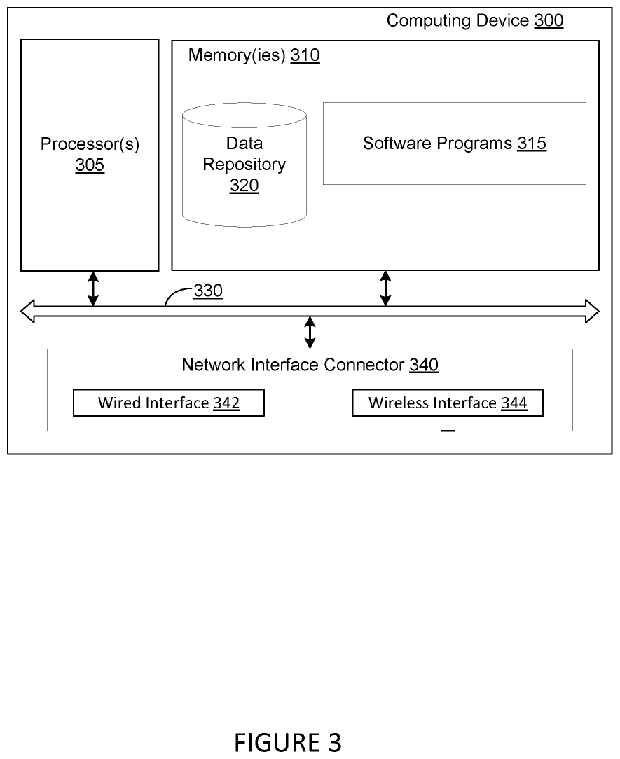

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Hereinafter, general aspects of implementation of the systems and methods of the invention will be described.

The system of the invention or portions of the system of the invention may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general-purpose computer, etc. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for dynamic escrow management, comprising:
receiving, by an escrow management computer program executed by an electronic device, an escrow agreement between a first party and a second party to a deal;
extracting, by the escrow management computer program and using natural language processing, an identification of the first party, an identification of the second party, terms of the escrow agreement, and an identification of authorized signors for the first party and the second party;
receiving, by the escrow management computer program, an escrow deposit from the first party or the second party;
confirming, by the escrow management computer program, that an amount of the escrow deposit meets a term of the escrow agreement;
depositing, by the escrow management computer program, the escrow deposit into an escrow account;
receiving, by the escrow management computer program, an escrow instruction from the first party, wherein the escrow instruction is received as a completed instruction template at a web interface;
retrieving, by the escrow management computer program, an identification of authorized signor for the first party;
routing, by the escrow management computer program, the escrow instruction to the authorized signor from the first party;
receiving, by the escrow management computer program, approval for the escrow instruction; and
causing, by the escrow management computer program, execution of the escrow instruction.

2. The method of claim 1, wherein the escrow management computer program predicts the authorized signors using a trained machine learning engine.

3. The method of claim 1, further comprising:
enrolling, by the escrow management computer program, the authorized signor for the first party in online access to the escrow management computer program.

4. The method of claim 1, further comprising:
performing, by the escrow management computer program, due diligence on the first party and the second party.

5. The method of claim 1, wherein the escrow instruction comprises a release of the escrow deposit.

6. The method of claim 1, further comprising:
storing, by the escrow management computer program, the approval for the escrow instruction.

7. The method of claim 1, wherein the approval for the escrow instruction comprises an electronic signature for the authorized signor for the first party.

8. The method of claim 1, wherein a payment system is configured to execute the escrow instruction.

9. A system, comprising:
a first party electronic device for a first party;
a dynamic template database comprising a plurality of dynamic templates;
an escrow account;
an escrow management computer program executed by an electronic device that receives an escrow agreement between the first party and a second party to a deal from the first party electronic device, extracts, using natural language processing, an identification of the first party, an identification of the second party, terms of the escrow agreement, and an identification of authorized signors for the first party and the second party, receives an escrow deposit from the first party or the second party, confirms that an amount of the escrow deposit meets a term of the escrow agreement, deposits the escrow deposit into the escrow account, receives an escrow instruction from the first party electronic device, wherein the escrow instruction is received as a completed dynamic template from the dynamic template database, retrieves an identification of authorized signor for the first party, routes the escrow instruction to the authorized signor from the first party, receives approval for the escrow instruction, and causes execution of the escrow instruction; and
a payment system that receives and executes the escrow instruction.

10. The system of claim 9, wherein the escrow management computer program predicts the authorized signors using a trained machine learning engine.

11. The system of claim 9, wherein the escrow management computer program enrolls the authorized signor for the first party in online access to the escrow management computer program.

12. The system of claim 9, wherein the escrow management computer program performs due diligence on the first party and the second party.

13. The system of claim 9, wherein the escrow instruction comprises a release of the escrow deposit.

14. The system of claim 9, further comprising a deal database, wherein the escrow management computer program stores the approval for the escrow instruction in the deal database.

15. The system of claim 9, wherein the approval for the escrow instruction comprises an electronic signature for the authorized signor for the first party.

16. A non-transitory computer readable storage medium, including instructions stored thereon, which when read and executed by one or more computer processors, cause the one or more computer processors to perform steps comprising:
receiving an escrow agreement between a first party and a second party to a deal;
extracting, using natural language processing, an identification of the first party, an identification of the second party, terms of the escrow agreement, and an identification of authorized signors for the first party and the second party;
receiving an escrow deposit from the first party or the second party;
confirming that an amount of the escrow deposit meets a term of the escrow agreement;
depositing the escrow deposit into an escrow account;
receiving an escrow instruction from the first party, wherein the escrow instruction is received as a completed instruction template at a web interface;
retrieving an identification of authorized signor for the first party;
routing the escrow instruction to the authorized signor from the first party;
receiving approval for the escrow instruction; and
causing execution of the escrow instruction.

17. The non-transitory computer readable storage medium of claim 16, wherein the authorized signors are predicted using a trained machine learning engine.

18. The non-transitory computer readable storage medium of claim 16, wherein the escrow instruction comprises a release of the escrow deposit.

19. The non-transitory computer readable storage medium of claim 16, further including instructions stored thereon, which when read and executed by one or more computer processors, cause the one or more computer processors to store the approval for the escrow instruction.

20. The non-transitory computer readable storage medium of claim 16, wherein the approval for the escrow instruction comprises an electronic signature for the authorized signor for the first party.
